(19) United States
(12) Patent Application Publication
(10) Pub. No.: US 2006/0279097 A1
(43) Pub. Date: Dec. 14, 2006

(54) Pet waste retrieval and storage bag

(76) Inventors: Robert J. Jones, Prior Lake, MN (US); Michael R. Jones, Apple Valley, MN (US)

Correspondence Address: MERCHANT & GOULD PC, P.O. BOX 2903, MINNEAPOLIS, MN, 55402-0903, US

(21) Appl. No.: 11/152,039

(22) Filed: Jun. 13, 2005

(51) Int. Cl. A01K 29/00

(52) U.S. Cl. 294/1.3

(57) ABSTRACT

The disclosure is directed to a sanitary collapsible pet waste retrieval and storage device that is simple and easy to operate. The device includes a bag and a pair of panels attached to opposing sides of the bag. The panels and bag are sized and configured such that rotating and moving scraping edges of the panels together scoops waste into the bag and positions the scraping edges within the bag.

### TECHNICAL FIELD

This disclosure relates to retrieval and disposal devices for pet feces. In particular, the disclosure is directed to modified bags that can be conveniently used to sanitarily pick up and store pet feces until ultimate disposal.

### BACKGROUND

Studies have shown that pet waste that is not picked up and properly disposed of presents environmental and health and safety problems. To combat these problems, many municipalities have introduced ordinances requiring that pet owners retrieve and properly dispose of the their pet's feces. Such ordinances have motivated the development of devices for individuals to conveniently satisfy this obligation.

Ordinary plastic bags have been widely used to pick up and temporarily store pet feces. One common method of using standard plastic bags to accomplish this task while avoiding direct physical contact between one's hand and the feces is to place the bag over one's hand, grab the feces such that the bag is positioned between one's hand and the feces, and invert the bag so that the feces are contained within the bag. A disadvantage of using an ordinary plastic bag in the above-described manner is that even thought the feces never directly contact the user's hand, the waste must nonetheless be grasped with the fingers, which is highly distasteful for many individuals. In addition, if the waste is soft, it can be difficult to completely remove all the waste from the grass and other ground surfaces. Therefore, there is a need for improved pet waste retrieval and storage devices that provide a unique method of retrieval that takes into consideration the challenges of environmental and health concerns that pet feces retrieval and disposal presents.

Unfortunately, many of the known devices developed for this purpose include complicated and cumbersome structural features that make them difficult to carry when walking a pet and thus are not widely used. Other devices leave offensive material exposed on external surfaces of the device after the removal operation is performed. Still other devices include non-disposable contaminated portions that require unpleasant cleaning to minimize the health and safety risk associated with the use and storage of feces contaminated devices.

Accordingly, there is a need for a device that is convenient to carry before and after use while walking one's pet, that is simple to use and easy to manufacture, which would insulate the user from contact with the feces and/or any parts of the device that could have contacted the feces.

### SUMMARY

The disclosure is directed at a device for collecting and storing pet feces that includes: a bag constructed of a flexible sheet material that includes an open end and a closed end; and a pair of opposed panels connected to the bag at the open end, wherein the panels have a width equaling less than or equal to half of the length of the periphery edge and are configured such that they can conveniently be used to scrape the bag against the contaminated surface thereby scooping feces into the bag. The present disclosure is also directed at manufacturing the same and features of enclosing the contamination edges within the bag for handling and transport.

### BRIEF DESCRIPTION OF THE DRAWINGS

Referring to the Figures, wherein like numerals represent like parts throughout the several views:

FIG. 1 is a perspective view of a pet waste retrieval and storage bag shown in an open state;

FIG. 2 is a perspective view of the pet waste retrieval and storage bag of FIG. 1 shown in a closed state;

FIG. 3 is a side elevation view of the pet waste retrieval and storage bag of FIG. 1;

FIG. 4 is a side elevation view of the pet waste retrieval and storage bag of FIG. 1 during one phase of the manufacturing process;

FIG. 5 is a cross-sectional view along line 5-5 of FIG. 2;

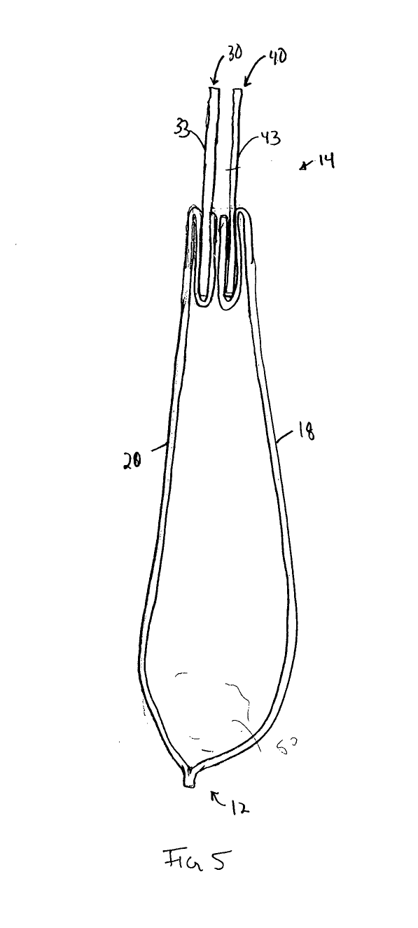

FIG. 6 is a perspective view of an alternative embodiment of a pet waste retrieval and storage bag shown in an open state;

FIG. 7 is a side elevation view of the pet waste retrieval and storage bag of FIG. 6;

FIG. 8 is a perspective view of the pet waste retrieval and storage bag of FIG. 6 shown in a closed state; and

FIG. 9 is a cross-sectional view along line 9-9 of FIG. 8.

### DETAILED DESCRIPTION

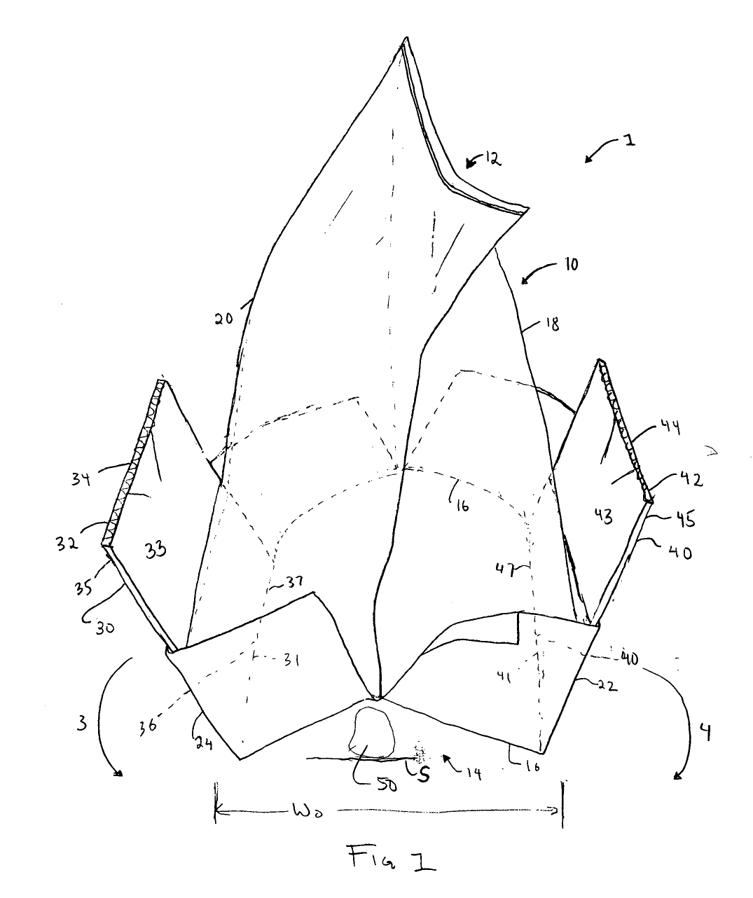

FIG. 1 is a perspective view of one embodiment of a pet waste retrieval and storage bag 1 configured according to the present invention. The pet waste retrieval and storage bag 1 includes a bag 10 and a pair of panels 30 and 40 attached thereto. In the embodiment shown, the bag is constructed of a flexible plastic and the panels 30 and 40 are constructed of corrugated cardboard. It should be understood that many alternative materials can be employed, some of which will be discussed in more detail below.

Still referring to FIG. 1, the bag 10 includes a first major side surface 20 and a second major side surface 18 that are connected together. The bag 10 also includes a closed end 12 and an open end 14. The side walls at the opening are folded over to form two flaps 22 and 24 and a peripheral edge 16 that defines the opening into the inner cavity of the bag. The flaps 24 and 22 are shown as turned up portions of the bag 10 that are adhered to lower portions 31 and 41 of the panels 30 and 40, respectively. More specific details regarding the interface between the panels 30 and 40 and the bag 10 are discussed in greater detail below.

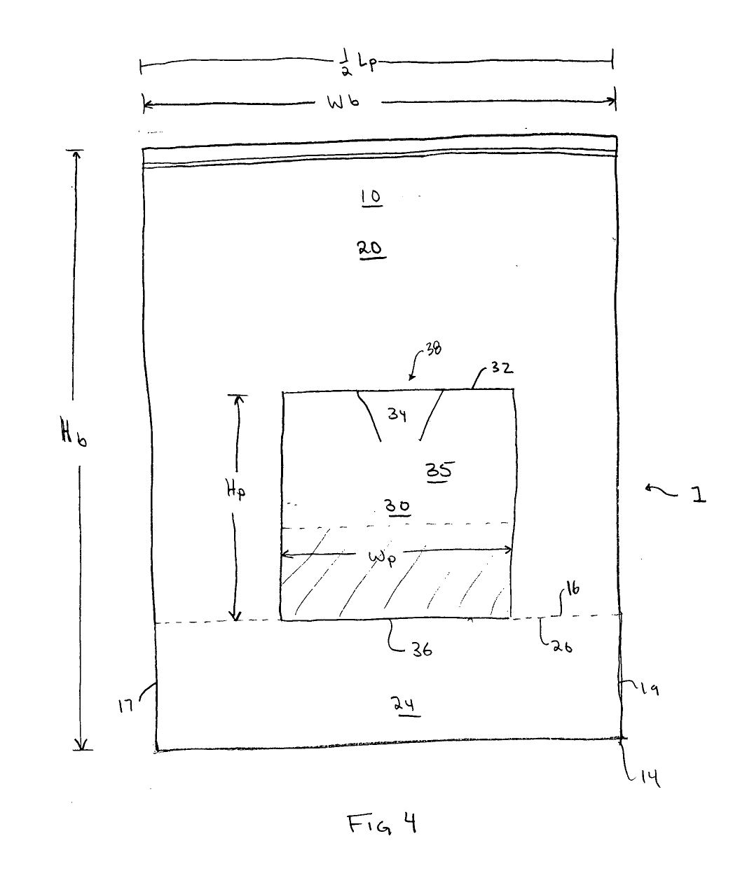

The panels 30 and 40 include inside surfaces 33 and 43 and outside surfaces 35 and 45, respectively. The panels 30, 40 include first end portions 31 and 41 (also referred to as lower portions), second end portions 32 and 42 (also referred to as upper portions), and locking mechanisms 34 and 44 disposed at the second end portions 32 and 42. The inside and outside surfaces 33, 35 of the panel 30 at the first end portion 31 are attached to the first major surface 20 of the bag 10. Likewise, the inside and outside surfaces 43, 45 of the panel 40 at the first end portion 41 are adhered to the first major surface 18 of the bag 10. The panels 30 and 40 have a width Wp that is less than or equal to half of the length Lp of the peripheral edge 16 (see FIG. 4). In the embodiment shown, the length Lp of the periphery edge 16 is equal to twice the width Wb of the primary surface 20 of the bag 10. In the embodiment shown, the difference between the width Wb of the primary surface 20 or 18 and the width Wp of the panel 30 or 40 is approximately the width Wo of the opening at the open end 16 of the bag 10.

In use, the bag 10 is positioned by grasping the panels 30, 40 such that the open end 14 of the bag 10 is centered over the waste 50 and end portions 32, 42 of the panels 30, 40 are positioned towards the closed end 12 of the bag. The scraping edges 36 and 46 as shown in FIG. 1 of the lower portions 31 and 41 of the bag 10 can be used to press the bag 10 against the contaminated surface S such that simultaneously rotating and moving together the first panel 30 and the second panel 40 in the direction shown by arrows 3 and 4 moves the edges 37 and 47 towards one another so as to engage and lift the waste 50 into the open end 14 of the bag 10. Alternatively, one panel can be held stationary while the other is moved towards the stationary panel to scrape feces into the inner cavity of the bag 10.

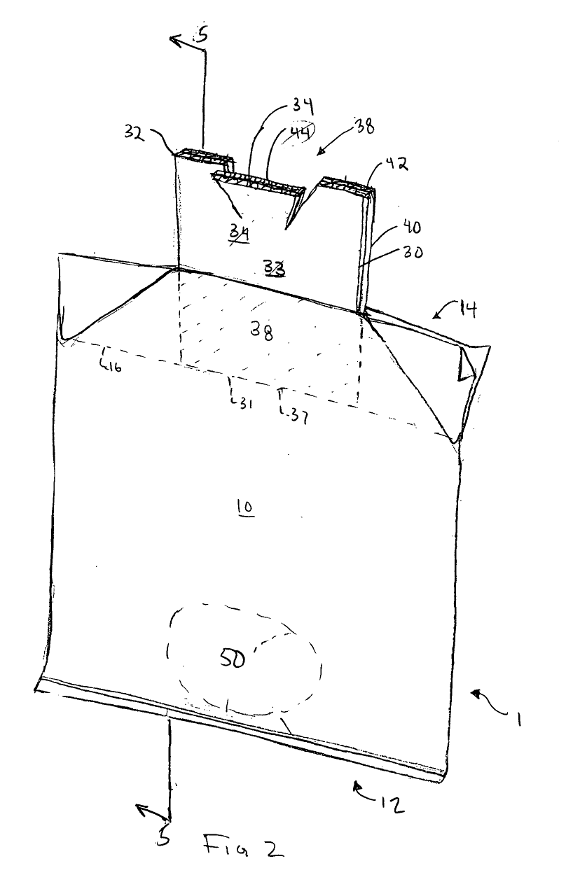

Once the waste 50 is in the bag 10, the pet waste retrieval and storage bag 1 can be flipped over as shown in FIG. 2. Flipping bag 10 from the position shown in FIG. 1 to the position shown in FIG. 2 causes the waste 50 to move from the open end 14 of the bag 10 to the closed end 12 of the bag 10. In the flipping process the user can continue to rotate the panels 30, 40 until they are engaged, thus closing the open end of the bag 10. Once closed, the lower portions 31, 41 of the panels 30, 40 are disposed within the bag.

Now referring to FIG. 2, a pet waste retrieval and storage bag 1 containing a piece of waste 50 is shown in a closed state. In the closed state, the first panel 30 is shown positioned adjacent the second panel 40 such that the outside surface 35 of the first panel 30 and the outside surface 45 of the second panel 40 are adjacent each other. The second ends 32, 42 of the first and second panels 30, 40 are disposed away from the bag 10 and, as discussed above, the first ends or lower ends 31 and 41 are disposed within the bag 10. The orientation described above where the second ends 32 and 42 are internal to the pet waste retrieve and storage bag 1 is preferred because the portions of the bag 10 located at the lower ends 31 and 41 of the panels 30 and 40 are likely to be contaminated by the waste 50 as a result of direct contact with the waste 50 during the scraping and scooping process described above.

Still referring to FIG. 2, the locking mechanism 38 is shown engaged. In the embodiment shown, the locking mechanism 38 is shown as tabs 34 and 44 that are partially cut portions located on the second end portions 32 and 42 of the panels 30 and 40. The tabs 34 and 44 can be bent to one side or another in such a way that they engage and interlock to aid in keeping the open end 14 of the bag 10 closed.

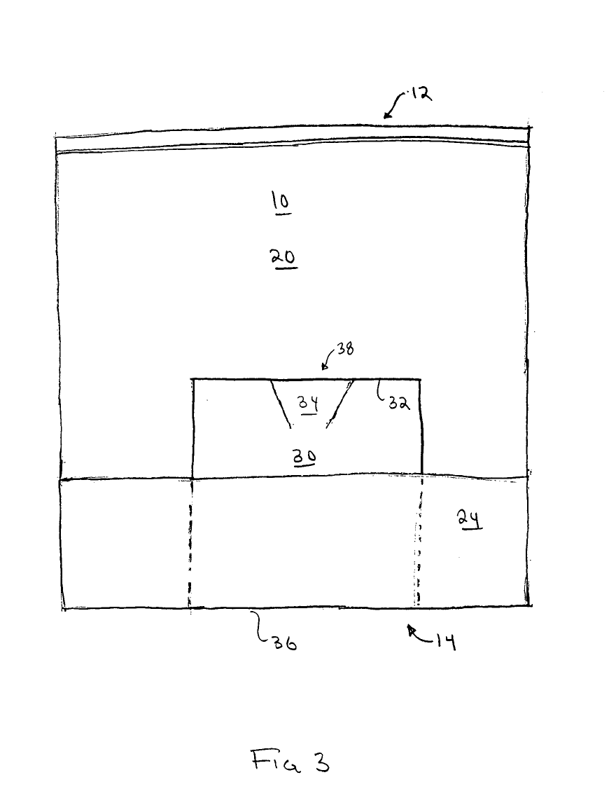

Referring now to FIGS. 3 and 4, the manufacturing process of the above-described pet waste retrieval and storage bag 1 is described in greater detail. Since the manufacturing process applicable for both sides of the pet waste retrieval and storage bag 1 is identical, the manufacturing step of only one side is described herein.

In the embodiment shown, a score line 26 is made in the bag 10 to aid in folding. The open end 14 of the bag 10 is cut along the edges 17 and 19 up to the score line 26 to form the flap 24. A panel 30 having a width Wp that is less than the width Wb of the bag 10 is positioned with its scraping edge 36 along the score line 26. The portion of the inside surface 33 near the first end portion 31 is glued or fused to the bag 10. The flap 24 is then folded towards the panel 30 and glued or fused to the portion of the outside surface 35 near the first end portion 31 of the panel 30. The same process is repeated for the second side 18 of the bag 10 using the panel 40 to complete the assembly process resulting in the pet waste retrieval and storage bag 1 shown in FIG. 3.

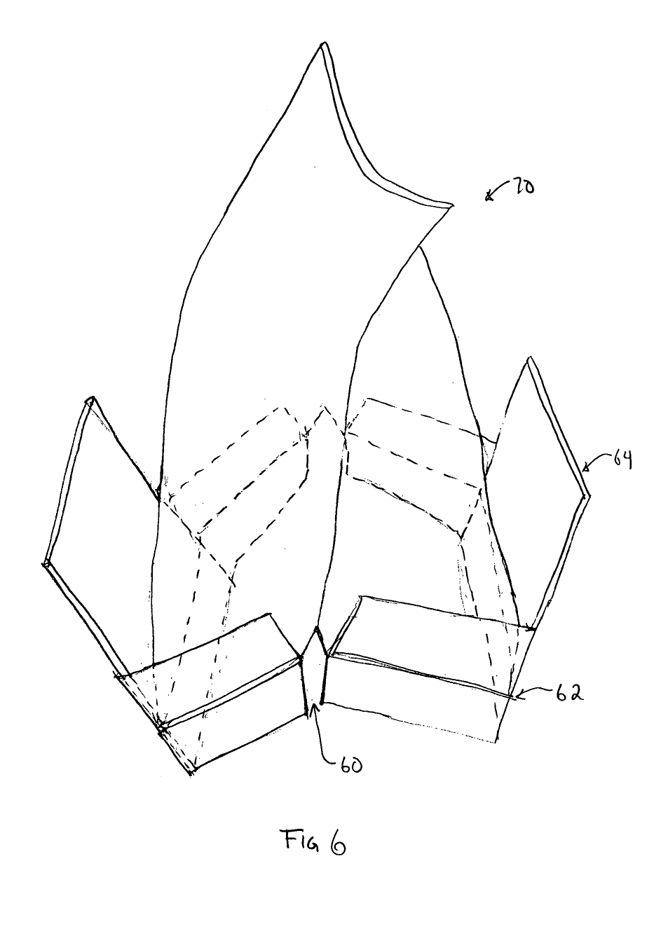

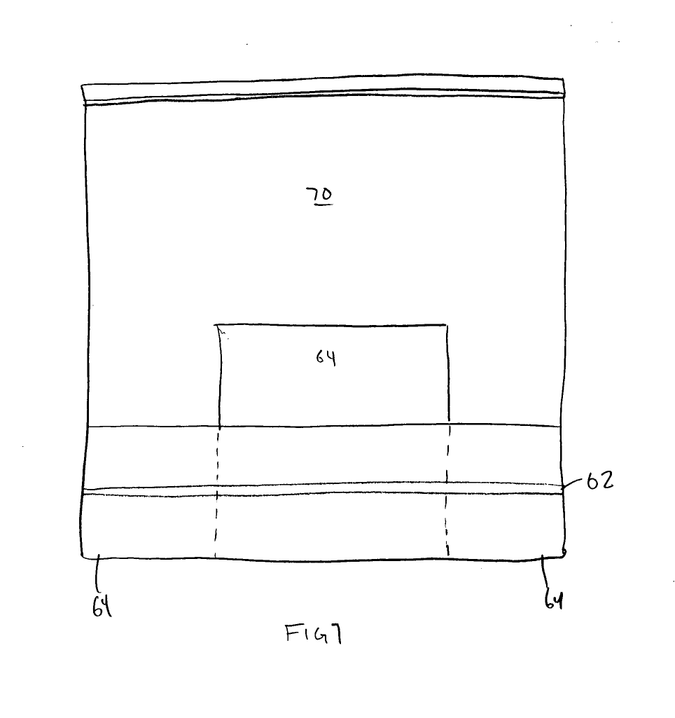

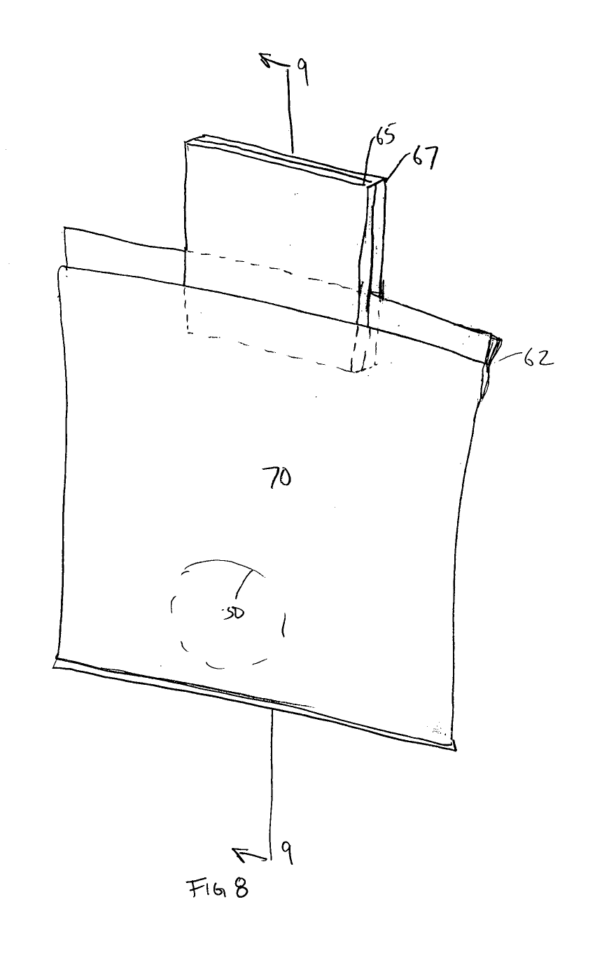

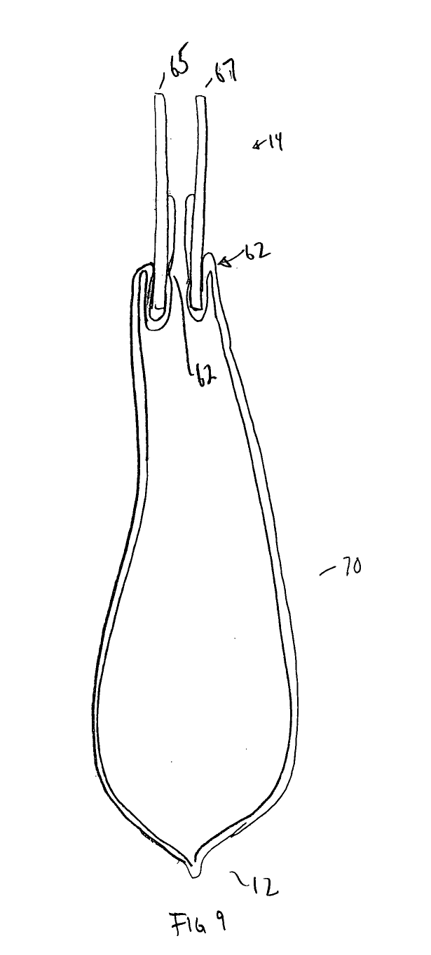

With respect to the material used to construct the pet waste retrieval and storage bag 1, it should be appreciated that various different materials other than plastic can be used in the construction of the bag 10. For example, the bag 10 could be constructed of paper, paper with a wax treatment, or a cloth material lined or coated with a plastic material. In addition, the bag 10 shown is a flat bag, however, it should be appreciated that the bag may include gussets. Similarly, it should be understood that many other materials other than corrugated cardboard can be used in the construction of the panels 30 and 40. For example, the panels can include plastic, wood, or other composite constructions. In the embodiment shown in FIGS. 6-9, the panels 65, 67 are shown constructed of plastic. The bag 70 shown in FIGS. 6-8 also includes slits 60. The slits 60 enable the corners 64 of the bag 70 to fold in toward each other when the bag 70 is in the closed position as shown in FIGS. 8-9.

In addition, it should be understood that though in the embodiment shown the bag 10 includes only two major surfaces 20 and 18, which are connected at their periphery edges, other embodiments may include additional intermediate side surfaces used to connect the first and second major side surfaces 20, 18 together.

Moreover, it should be understood that in some embodiments, pet waste retrieval and storage bag 1 does not include flap portions 22, 24. In these embodiments, the panels 30 and 40 are connected to the bag 10 only at their first major surfaces 33 and 43. In addition, it should be understood that the panels 30 and 40 are not necessarily connected to the bag 10 with adhesives such as glue. In the embodiment shown in FIGS. 6-9, the bag is fused or melted to the plastic panels 30, 40 along fuse line 62. In other embodiments, the panels 30 and 40 can be, for example, stapled, taped, sewn, heat sealed, or clipped to the bag 10. Numerous additional means to attach the bag 10 to the panels 30, 40 are possible.

In some embodiments the device is sized to be conveniently carried in ones purse or pockets. In such embodiments, the bag can be folded over the panels such that the overall length and width dimensions of the device are substantially the same as the length and width dimensions of the panels. In some preferred embodiments each panel has a surface area of less than 100 square inches and more preferably each panel has a surface area of less than 36 square inches.

The above specification, examples, and data provide a complete description of the manufacture and use of the composition of the invention. Since many embodiments of the invention can be made without departing from the spirit and scope of the invention, the invention resides in the claims hereinafter appended.

1. A device for collecting and storing pet feces comprising:
a bag comprising flexible sheet material having an open end and a closed end; the open end including a periphery edge;
a pair of opposed panels connected to the bag at the open end wherein the panels have a width equaling less than or equal to half of a length of the periphery edge; and
wherein the entire periphery edge of the bag folds inward when the panels are pivoted to a closed position.

2. The device according to claim 1, wherein the bag is constructed of a first material and the panels are constructed of a second material, wherein the first material is more flexible than the second material.

3. The device according to claim 1, wherein the bag is constructed of plastic.

4. The device according to claim 1, wherein the panels are constructed of cardboard.

5. The device according to claim 1, wherein the panels are constructed of plastic.

6. The device according to claim 1, wherein the panels include first ends attached to the open end of the bag and second ends not attached to the bag.

7. The device according to claim 4, wherein the panels include locking mechanisms disposed at the second ends of the panels that are constructed to secure the panels to each other.

8. The device according to claim 1, wherein the panels are connected to outer surfaces of the bag.

9. The device according to claim 1, wherein the panels are glued to the bag.

10. The device according to claim 5, wherein the panels are fused to the bag.

11. The device according to claim 1, wherein the bag includes opposed slits that enable corners of the bag to fold in towards each other.

12. A method of manufacturing a device for collecting and storing pet feces comprising the steps of:
providing a gussetless bag constructed of a flexible material having an open end and a closed end;
creating a pair of opposed slits along the open end of the bag;
positioning a scraping edge of a pair of panels constructed of a material more rigid than the bag material on opposed outer surfaces of the bag, each scraping edge being positioned laterally between the slits and vertically below the open end of the bag and above the bottom of the slits;
folding open end portions of the bag over the scraping edges thereby defining a double walled periphery edge and connecting the bag to the panels such that the panels are disposed outside of the bag with the scraping edge flush with the periphery edge.

13. The method according to claim 12, wherein the step of connecting the panels to the open end of the bag includes the steps of adhering a portion of a first side of a first panel to an outer surface of the bag and adhering a portion of a second side of a first panel to a folded over portion of the bag, wherein the first and second sides are opposed major surfaces of the first panel.

14. The method according to claim 12, wherein the step of connecting the panels to the open end of the bag includes the steps of fusing a portion of the bag to the panels and fusing a folded over portion of the bag adjacent the panels to itself.

15. The method according to claim 12, further comprising the step of forming interlocking tab portions at an edge of the panels.

16. A device for collecting and storing pet feces comprising:
a flat style plastic bag having an open end;
a pair of panels each panel having two primary surfaces, wherein only one of the primary surfaces of each panel is fused to the plastic bag to form a pair of scraping edges and wherein the panels are configured and attached to the bag such that the pair of scraping edges are covered by portions of the plastic bag.

17. The device according to claim 16, wherein the pair of scraping edges are disposed inside the bag when the bag is in the closed position.

18. The device according to claim 16, wherein the bag is constructed to fold over and around the panels so that the length and width of the device prior to use is substantially the same as the overall length and width of the panels.

19. The device according to claim 16, wherein a front and back sides of the end of the panels proximate the scraping edge are covered by the bag.

20. The device according to claim 16, wherein a folded over portion of the bag adjacent the panels is fused to the bag.
